(19) United States
(12) Patent Application Publication
(10) Pub. No.: US 2017/0350096 A1
(43) Pub. Date: Dec. 7, 2017

(54) HYDRAULIC PUMP CONTROL APPARATUS FOR CONSTRUCTION EQUIPMENT AND CONTROL METHOD THEREOF

(71) Applicants: Sung-yong JO, Gyeongsangnam-do 642-370 (KR); VOLVO CONSTRUCTION EQUIPMENT AB, Eskilstuna (SE)

(72) Inventors: Sung-Yong JO, Gyeongsangnam-do (KR); Hyung-Seok PARK, Gyeongsangnam-do (KR); Jae-Hoon LEE, Gyeongsangnam-do (KR)

(73) Assignee: VOLVO CONSTRUCTION EQUIPMENT AB, Eskilstuna (SE)

(21) Appl. No.: 15/536,752

(22) PCT Filed: Jan. 9, 2015
(86) PCT No.: PCT/KR2015/000244

§ 371 Date: Jun. 16, 2017

(51) Int. Cl. E02F 9/22

(52) U.S. Cl. CPC E02F 9/2232; E02F 9/2292; E02F 9/2285; F15B 2211/30555; F15B 2211/428; F15B 2211/6316; F15B 2211/30565

(57) ABSTRACT

A hydraulic pump control apparatus for construction equipment includes a first hydraulic pump; a first hydraulic actuator driven by the hydraulic oil of the first hydraulic pump; a first control valve installed on the fluid channel of the first hydraulic pump; a second hydraulic pump connected, to a power take-off apparatus of an engine; a second hydraulic actuator driven by the hydraulic oil of the second hydraulic pump; a second control valve installed on the fluid channel of the second hydraulic pump; a pressure sensor that detects the pressure of the second hydraulic pump; a regulator that controls the amount of oil discharged from the first hydraulic pump; and a controller that computes a horse power value using the detected pressure value of the second hydraulic pump and the amount of oil discharged from the second hydraulic pump and inputs a control signal to the regulator to discharge an amount of oil that corresponds to the difference between the maximum working horse power value of the engine and the computed horse power value of the second hydraulic pump.

### BACKGROUND AND SUMMARY

The present invention relates to a hydraulic pump control apparatus for construction machine and control method thereof, and more particularly, a hydraulic pump control apparatus for construction machine and the control method thereof in order to utilize a maximum horse power available of an engine in case that a plurality of hydraulic pumps are connected to the engine.

FIG. 1 is a hydraulic circuit of a hydraulic pump control apparatus for construction machine according to the conventional technology.

As shown FIG. 1, a first variable displacement hydraulic pump (hereinafter, “first hydraulic pump”)(1) is connected to an engine (2).

A first hydraulic actuator (3) (e.g. boom cylinder) is connected to the first hydraulic pump (1) through a hydraulic path (4), which drives the working device by the hydraulic fluid of the first hydraulic pump (1).

A first control valve (5) is installed in the path (4) between the first hydraulic pump (1) and the first hydraulic actuator (3), which controls the hydraulic fluid supplied to the first hydraulic actuator (3) as the first control valve (5) is shifted by the pilot pressure from the operation lever (not shown in figure).

At least one of second hydraulic pumps (7) are connected to the power take-off (PTO) apparatus of the engine (2). A second hydraulic actuator (8) is connected to the second hydraulic pump (7) through a hydraulic path (9), which drives the hydraulic apparatus (not shown in figure) by the hydraulic fluid of the second hydraulic pump (7).

A second control valve (12) is installed in the path (9) between the second hydraulic pump (7) and the second hydraulic actuator (8), which controls the hydraulic fluid supplied to the second hydraulic actuator (8) as the second control valve (12) is shifted by the pilot pressure from the operation lever (not shown in figure).

A controller (10) for controlling the discharge flow rate of the first hydraulic pump (1) is connected to a regulator (11) for adjusting the swash plate swivel angle of the first hydraulic pump (1).

The horse power of the first hydraulic pump (1) is set to be less than the difference between maximum horse power available of the ermine (2) and the maximum horse power that can be outputted from the second hydraulic pump (7).

The reason for restricting the horse power of the first hydraulic pump (1) is because the load generated in the second hydraulic pump (7) is determined by the second hydraulic actuator (8) and varies depending on the working and environmental conditions.

Therefore, if the sum of the horse powers generated in the second hydraulic pump (7) and in the first hydraulic pump (1) exceeds the maximum horse power available of the engine (2), it causes the problem such as ‘stall’ in the engine (2). By the same token, the stability of hydraulic circuit can be secured by setting the appropriate horse power of the first hydraulic pump (1) based on the maximum horse power of the second hydraulic pump (7).

In addition, if the horse power of the second hydraulic pump (7) does not reach the maximum horse power, the horse power of the first hydraulic pump (1) might be raised to an available value of the maximum horse power, which is, however, not the case with the work efficiency lowered.

FIG. 2 is a hydraulic circuit of a hydraulic pump control apparatus for construction machine according to another conventional technology.

As shown FIG. 2, a first variable displacement hydraulic pump (hereinafter, “first hydraulic pump”)(1) is connected to an engine (2).

A first hydraulic actuator (3) (e.g. boom cylinder) is connected to the first hydraulic pump (1) through a hydraulic path (4), which drives the working device by the hydraulic fluid of the first hydraulic pump (1).

A first control valve (5) is installed in the path (4) between the first hydraulic pump (1) and the first hydraulic actuator (3), which controls the hydraulic fluid supplied to the first hydraulic actuator (3) as the first control valve (5) is shifted by the pilot pressure from the operation lever (not shown in figure).

At least one of second hydraulic pumps (7) are connected to the power take-off (PTO) apparatus of the engine (2). A second hydraulic actuator (8) is connected to the second hydraulic pump (7) through a hydraulic path (9), which drives the hydraulic apparatus (not shown in figure) by the hydraulic fluid of the second hydraulic pump (7).

The second control valve (12) is installed in the path (9) between the second hydraulic pump (7) and the second hydraulic actuator (8), which controls the hydraulic fluid supplied to the second hydraulic actuator (8) as the second control valve (12) is shifted by the pilot pressure from the operation lever (not shown in figure).

A controller (10) for controlling the discharge flow rate of the first hydraulic pump (1) is connected to a regulator (11) for adjusting the swash plate swivel angle of the first hydraulic pump (1).

A engine RPM detection apparatus (13) for detecting RPM of the engine (2) is connected to the controller (10).

When the horse power of the engine (2) is determined, the engine RPM is detected lye the detection apparatus (13) and the detected signal is inputted to the controller (10).

The controller (10) compares the detected engine RPM with a rated RPM, and if the detected RPM is less than the rated RPM, a control signal is outputted to the regulator (11) to reduce the discharge flow rate of the first hydraulic pump (1), thus preventing the stall of engine (2).

The engine (2) RPM gets lower than the rated RPM, if the sum of loads generated in the second hydraulic actuator (8) and in the first hydraulic pump (1) exceeds the maximum horse power available of the engine (2).

At this moment, the work efficiency can be improved by preventing the stall of engine (2) as the discharge flow rate of the first hydraulic pump (1) is reduced.

However, since the discharge flow rate of the first hydraulic pump (1) is controlled after comparing the sum of loads generated in the second hydraulic actuator (8) and in the first hydraulic pump (1) with the detected engine RPM, the engine RPM drop may occur due to the response lag.

Accordingly, it is desirable to provide a hydraulic pump control apparatus for construction machine and a control method thereof, by which the work efficiency and the responsivity are improved as the maximum horse power available of an engine is utilized with a plurality of hydraulic pumps connected to the engine.

In accordance with an embodiment of the present invention, there is provided a hydraulic pump control apparatus for construction machine comprising;

a first variable displacement hydraulic pump connected to an engine;

a first hydraulic actuator driven by the hydraulic fluid of the first hydraulic pump;

a first control valve that is installed in a hydraulic path of the first hydraulic pump, and controls the hydraulic fluid supplied to the first hydraulic actuator;

at least one of second hydraulic pumps connected to a power take-off (PTO) apparatus of the engine;

a second hydraulic actuator driven by the hydraulic fluid of the second hydraulic pump;

a second control valve that is installed in a hydraulic path of the second hydraulic pump, and controls the hydraulic fluid supplied to the second hydraulic actuator;

a pressure sensor that is installed in the path of the second hydraulic pump, and detects a hydraulic pressure of the second hydraulic pump;

regulator for adjusting a swash plate swivel angle of the first hydraulic pump in order to control a discharge flow rate of the first hydraulic pump; and,

a controller that inputs a control signal to a regulator so as to control the first hydraulic pump discharge flow rate corresponding to a difference between the maximum horse power available of the engine and the second hydraulic pump horse power which is calculated using the detected hydraulic pressure and a discharge flow rate of the second hydraulic pump.

According to the embodiment of the present invention, a method for controlling a hydraulic pump for construction machine, including a first variable displacement hydraulic pump connected to an engine; a first hydraulic actuator driven by the hydraulic fluid of the first hydraulic pump; a second hydraulic pumps connected to a power take-off (PTO) apparatus of the engine; a second hydraulic actuator driven by the hydraulic fluid of the second hydraulic pump; a pressure sensor that is installed in a flow path of the second hydraulic pump; a regulator for adjusting a swash plate swivel angle of the first hydraulic pump; and a controller to which a detected pressure signal from the pressure sensor is inputted, the method comprises;

a step of calculating a horse power of the second hydraulic pump using the detected pressure and a discharge flow rate of the second hydraulic pump;

a step of comparing the magnitude of the calculated horse power of the second hydraulic pump with that of an available horse power;

a step of calculating a first discharge flow rate of the first hydraulic pump based on the ratio of the sum of the basic horse power of the first hydraulic pump and the available horse power to the load pressure of the first hydraulic pump, if the calculated horse power of the second hydraulic pump is less than the available horse power;

a step of calculating a second discharge flow rate of the first hydraulic pump based on the ratio of the basic horse power of the first hydraulic pump to the load pressure of the first hydraulic pump, if the calculated horse power of the second hydraulic pump is greater than the available horse power; and,

a step of inputting a control signal to the regulator so as to discharge the first and second calculated discharge flow rates of the first hydraulic pump.

The hydraulic pump control apparatus for construction machine and the control method thereof according to the present invention is further provided with an engine RPM detection apparatus for detecting engine RPM and inputting the detected signal to the controller, wherein the controller compares the detected engine RPM with a rated RPM, and if the detected RPM is less than the rated RPM, a control signal is inputted to the regulator so as to reduce a discharge flow rate of the first hydraulic pump.

According to the embodiment of the present invention having the above-described configuration, the work efficiency and the responsivity can be improved as the maximum horse power available of the engine is utilized for driving the hydraulic pump with a plurality of hydraulic pumps connected to the engine.

### BRIEF DESCRIPTION OF THE DRAWINGS

The above features and advantages of the present invention will become more apparent by describing the preferred embodiments thereof with reference to the accompanying drawings, in which:

FIG. 1 is a hydraulic circuit of the hydraulic pump control apparatus for construction machine according to the conventional technology.

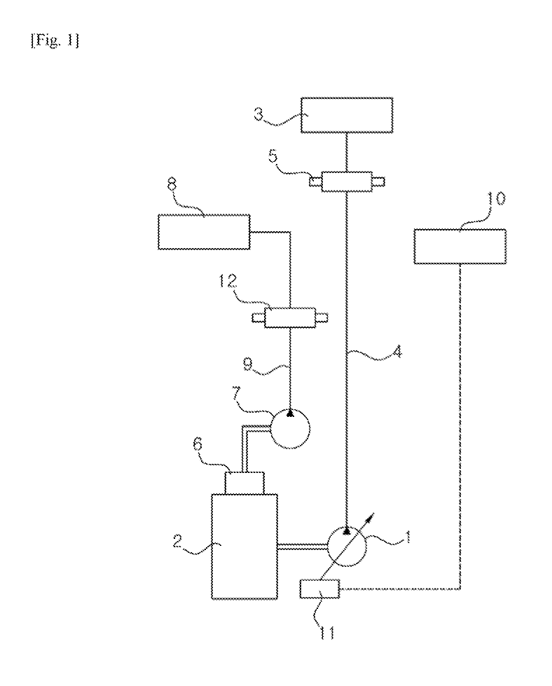

FIG. 2 is a hydraulic circuit of the hydraulic pump control apparatus for construction machine according to another coo conventional technology.

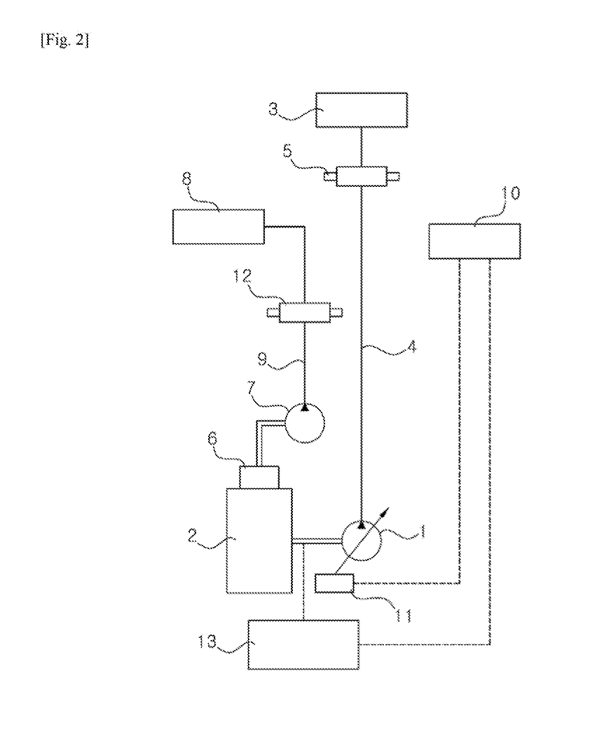

FIG. 3 is a hydraulic circuit of the hydraulic pump control apparatus for construction machine according to the embodiment of the present invention.

FIG. 4 is a flow chart of a control method of a hydraulic pump control apparatus for construction machine according to the embodiment of the present invention.

Explanation of reference numerals for main parts in the drawing
1; first hydraulic pump
2: engine
3; first hydraulic actuator
4, 9; path
5; first control valve
6; power take-off apparatus
7: second hydraulic pump
8; second hydraulic actuator
10; controller
11; regulator
12; second control valve
13; engine RPM detection apparatus
14; pressure detection apparatus

### DETAILED DESCRIPTION

Hereinafter, a hydraulic pump control apparatus for construction machine according to a preferred embodiment of the present invention will be described in detail with reference to the accompanying drawings.

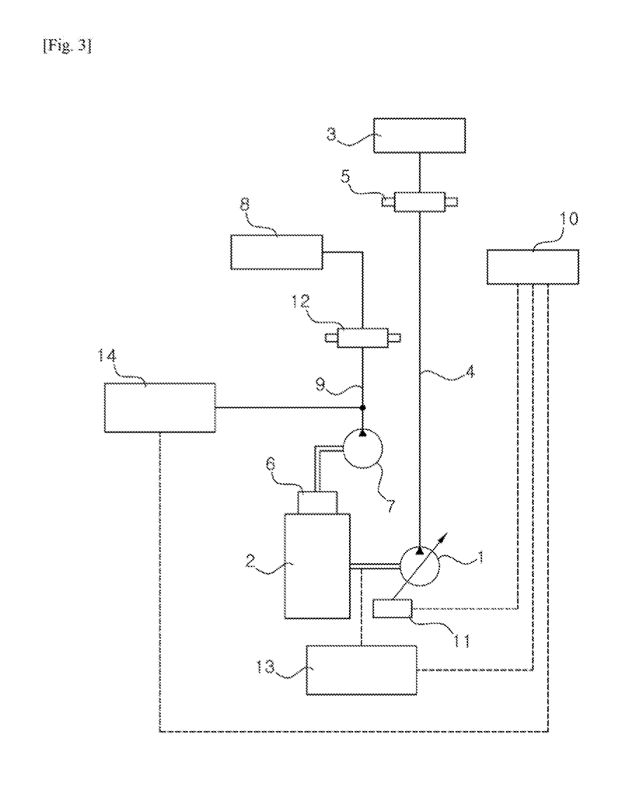

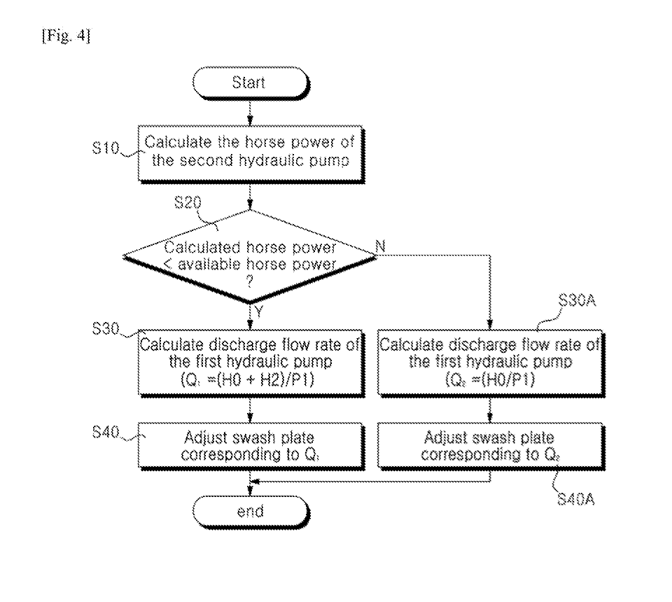

FIG. 3 is a hydraulic circuit of a hydraulic pump control apparatus for construction machine according to the embodiment of the present invention. FIG. 4 is a flow chart of a method fur controlling a hydraulic pump for construction machine according to the embodiment of the present invention.

Referring to FIG. 3, a first variable displacement hydraulic pump (hereinafter, “first hydraulic pump”) (1) is connected to an engine (2).

A first hydraulic actuator (3) (e.g. boom cylinder) is connected to the first hydraulic pump (1) through a hydraulic path (4), which drives the working device by the hydraulic fluid of the first hydraulic pump (1).

A first control valve (5) is installed in the flow path (4) between the first hydraulic pump (1) and the first hydraulic actuator (3), which controls the hydraulic fluid supplied to the first hydraulic actuator (3) as the first control valve (5) is shifted by a pilot pressure applied from an operation lever (not shown in figure).

At least one of second hydraulic pumps (7) are connected to a power take-off (PTO) apparatus of the engine (2). A second hydraulic actuator (8) is connected to the second hydraulic pump (7) through a flow path (9), which drives the hydraulic apparatus (not shown in figure) by the hydraulic fluid of the second hydraulic pump (7).

A second control valve (12) is installed in the path (9) between the second hydraulic pump (7) and the second hydraulic actuator (8), which controls the hydraulic fluid supplied to the second hydraulic actuator (8) as the second control valve (12) is shifted by a pilot pressure applied from an operation lever (not shown in figure).

A pressure sensor (14) is installed in a flow path of the second hydraulic pump, and detects a hydraulic pressure of the second hydraulic pump (7).

A controller (10) for controlling a discharge flow rate of the first hydraulic pump (1) is connected to a regulator (11) for adjusting the swish plate swivel angle of the first hydraulic pump (1).

The horse power (H1) of the second hydraulic pump (7) is calculated as H1=P2×Q2, where, P2 is the detected hydraulic pressure of the second hydraulic pump (7) and Q2 is a discharge flow rate of the second hydraulic pump (7). A control signal from the controller (10) is inputted to the regulator (11) so as to control the first hydraulic pump discharge flow rate corresponding to a difference between the maximus horse power available of the engine (2) and the calculated horse power, H1.

In addition, an engine RPM detection apparatus (13) for detecting engine RPM is connected to the controller (10) that compares the detected engine RPM with a rated RPM, and if the detected RPM is less than the rated RPM, a control signal form the controller (10) is inputted to the regulator (11) so as to, reduce the discharge flow rate of the first hydraulic pump (1).

At this point, due to the aging of the second hydraulic pump (7) or the engine (2), the error may occur between the calculated horse power of the second hydraulic pump (7) and the actual horse power value. Since the engine RPM detected by the detection apparatus (13) allows for the actual load detected by the pressure sensor (14) which is generated in the second hydraulic pump (7), the first hydraulic pump (1) can be accurately controlled.

Referring to FIG. 4, according to an embodiment of the present invention, a control method of a hydraulic pump control apparatus for construction machine, including a first variable displacement hydraulic pump (1) connected to an engine (2); a first hydraulic actuator (3) driven by the hydraulic fluid of the first hydraulic pump (1); a second hydraulic pump (7) connected to a power take-off (6)(PTO) apparatus of the engine (2); a second hydraulic actuator (8) driven by the hydraulic fluid of the second hydraulic pump (7); a pressure sensor (14) that is installed in a flow path (9) of the second hydraulic pump (7); a regulator (11) for adjusting a swash plate swivel angle of the first hydraulic pump (1); and a controller (10) to which a detected pressure signal from the pressure sensor (14) is inputted, the method comprises;

a step (S10) of calculating a horse power (H1=P2×Q2) of the second hydraulic pump (7) using a load pressure or a hydraulic pressure (P2) of the second hydraulic pump (7) detected by the pressure sensor (14) and a discharge flow rate (Q2) of the second hydraulic pump (7);

a step (S20) of comparing the magnitude of the calculated horse power (H1) of the second hydraulic pump (7) with that of an available horse power (H2) [For instance, assuming the horse power of engine (2) of 450 kw, a horse power of first hydraulic pump (1) of 400 kw and the parasitic horse power (used for driving the cooling fan, etc.) of 50 kw, respectively, if 30 kw of the parasitic horse power is assigned for the second hydraulic pump (7), then the assigned 30 kw is the available horse power (112) of the second hydraulic pump (7)];

a step (S30) of calculating a first discharge flow rate (Q₁(H0+H2)/P1) of the first hydraulic pump (1), which is corresponding to the proportion of the sum of a basic horse power (H0) of the first hydraulic pump (1) and the available horse power (H2) for a load pressure (P1) of the first hydraulic pump (1), if the calculated horse power (H1) of the second hydraulic pump (7) is less than the available horse power (H2) [For instance, assuming the horse power of engine (2) of 450 kw, the horse power of first hydraulic pump (1) of 400 kw and the parasitic horse power of 50 kw, respectively, the basic horse power (H0) is 400 kw.]

a step (S30A) of calculating a second discharge flow rate (Q₂=H0/P1) of the first hydraulic pump (1) which is corresponding to the proportion of the basic horse power (H0) of the first hydraulic pump (1) for the load pressure (P1) of the first hydraulic pump (1), if the calculated horse power (H1) of the second hydraulic pump (7) is greater than the available horse power (H2); and,

a step (S40, S40A) of inputting a control signal to the regulator (11) so as to discharge the first and second calculated discharge flow rates (Q₁, Q₂) of the first hydraulic pump (1).

According to the configuration describe above, as, in S10, a signal for the hydraulic pressure (P2) of the second hydra hydraulic pump (7) detected by the pressure sensor (14) is inputted to the controller (10), the horse power of the second hydraulic pump (7) (H1=P2×Q2) is calculated using the detected hydraulic pressure (P2) of the second hydraulic pump (7) and the discharge rate (Q2) of the second hydraulic pump (7). At this point, the maximum horse power of the first hydraulic pump (1) can be set to be the maximum horse power available of the engine (2) and the minimum horse power of the second hydraulic pump (7). After the horse power (H1) of the second hydraulic pump (7) is calculated, the step proceeds to “S20”.

As in S20, the magnitude of the calculated horse power (H1) of the second hydraulic pump (7) is compared with that of the available horse power (H2). If H1<H2, it proceeds to “S30”, and if H1>H2, it proceeds to “S30A”.

As in S30, the first discharge flow rate (Q₁=(H0+H2)/P1) of the first hydraulic pump (1) is calculated, which is corresponding to the proportion of the sum of the basic horse power (H0) of the first hydraulic pump (1) and the available horse power (H2) for the load pressure (P1) of the first hydraulic pump (1). Then it proceeds to “S40”.

As in S40, in order to discharge the first flow rate (Q₁) of the first hydraulic pump (1), the swash plate swivel angle of the first hydraulic pump (1) is adjusted by the control signal applied from the controller (10) to the regulator (11).

As in S30A, the second discharge flow rate (O₂=H0/P1) of the first hydraulic pump (1) is calculated, which is corresponding to the proportion of the basic horse power (H0) of the first hydraulic pump (1) for the load pressure (P1) of the first hydraulic pump (1). Then it proceeds to “S40A”.

As in S40A, in order to discharge the second discharge flow rate (Q₂) of the first hydraulic pump (1), the swash plate swivel angle of the first hydraulic pump (1) is adjusted by the control signal applied from the controller (10) to the regulator (11).

According to the embodiment of the present invention as described above, as the horse power available of the second hydraulic pump (7) is increased due to the load generated in the second hydraulic actuator (8), which can be sensed by the increased hydraulic pressure of the second hydraulic pump (7) detected by the pressure sensor (14), the maximum horse power available of the first hydraulic pump (1) can be variably set by subtracting the detected horse power of the second hydraulic pump (7) from the maximum horse power available of the engine (2).

Although the present invention has been described with reference to the preferred embodiment in the attached figures, it is to be understood that various equivalent modifications and variations of the embodiments can be made by a person having an ordinary skill in the art without departing from the spirit and scope of the present invention as recited in the claims.

### INDUSTRIAL APPLICABILITY

According to the present invention having the above-described configuration, the maximum horse power available of the engine can be utilized for driving the hydraulic pump in case that a plurality of hydraulic pumps are connected to the engine equipped in the construction machine such as excavator.

1. A hydraulic pump control apparatus for construction machine comprising;
a first variable displacement hydraulic pump connected to an engine;
a first hydraulic actuator driven by, the hydraulic fluid of the first hydraulic pump;
a first control valve that is installed in a flow path of the first hydraulic pump, and controls the hydraulic fluid supplied to the first hydraulic actuator;
at least one of second hydraulic pumps connected to a power take-off (PTO) apparatus of the engine;
a second hydraulic actuator driven by the hydraulic fluid of the second hydraulic pump;
a second control valve that is installed in a flow path of the second hydraulic pump, and controls the hydraulic fluid supplied to the second hydraulic actuator;
a pressure sensor that is installed in the flow path of the second hydraulic pump, and detects a hydraulic pressure of the second hydraulic pump;
a regulator for adjusting a swash plate swivel angle of the first hydraulic pump in order to control a discharge flow rate of the first hydraulic pump; and,
a controller that inputs a control signal to the regulator so as to control the first hydraulic pump discharge flow rate corresponding to a difference between the maximum horse power available of the engine and the second hydraulic pump horse power which is calculated using the detected hydraulic pressure and a discharge flow rate of the second hydraulic pump.

2. The hydraulic pump control apparatus for construction machine of claim 1, further comprising an engine RPM detection apparatus for detecting engine RPM and inputting the detected signal to a controller, wherein the controller compares the detected engine RPM with a rated RPM, and if the detected RPM is less than the rated RPM, a control signal from the controller is inputted to the regulator so as to reduce the discharge flow rate of the first hydraulic pump.

3. A control method of a hydraulic pump for construction machine, including a first hydraulic pump connected to an engine; a first hydraulic actuator driven by the hydraulic fluid of the first hydraulic pump; a second hydraulic pump connected to a power take-off (PTO) apparatus of the engine; a second hydraulic actuator driven by the hydraulic fluid of the second hydraulic pump; a pressure sensor that is installed in a flow path of the second hydraulic pump; a regulator for adjusting a swash plate swivel angle of the first hydraulic pump; and a controller to which a detected pressure signal from the pressure sensor is inputted, the method comprising;
calculating a horse power of the second hydraulic pump using the detected pressure and a discharge flow rate of the second hydraulic pump;
a step of comparing the calculated horse power of the second hydraulic pump with an available horse power;
calculating a first discharge flow rate of the first hydraulic pump based on the ratio of the sum of the basic horse power of the first hydraulic pump and the available horse power to the load pressure of the first hydraulic pump, if the calculated horse power of the second hydraulic pump is less than the available horse power;
calculating a second discharge flow rate of the first hydraulic pump based on the ratio of the basic horse power of the first hydraulic pump to the load pressure of the first hydraulic pump, if the calculated horse power of the second hydraulic pump is greater than the available horse power; and,
inputting a control signal to the regulator so as to discharge the first and second calculated discharge flow rates of the first hydraulic pump.
